(19) United States
(12) Patent Application Publication
(10) Pub. No.: US 2016/0009568 A1
(43) Pub. Date: Jan. 14, 2016

(54) Rainwater Capture System and Method

(71) Applicant: Sky Springs, LLC, Austin, TX (US)

(72) Inventor: Jon Marc Howell, Austin, TX (US)

(21) Appl. No.: 14/325,858

(22) Filed: Jul. 8, 2014

(51) Int. Cl. C02F 1/00; G05B 15/02; G05D 7/06; C02F 1/467

(52) U.S. Cl. CPC C02F 1/008; C02F 1/4672; G05B 15/02; G05D 7/0635; C02F 2209/06; C02F 2209/40; C02F 2209/11; C02F 2303/04; C02F 2201/782

(57) ABSTRACT

Systems and methods for collecting rainwater may include detecting a flow of rainwater via a flow meter and automatically switching a valve to direct the flow of rainwater through a first tank that may include a measurement system. The measurement system may measure parameters associated with the flow of rainwater. The parameters may include pH level and rainwater clarity, among others. A controller may determine that each of the parameters may have met a respective criterion and automatically switch at least one second valve to re-direct the flow of rainwater to a second tank for holding collected rainwater. Once the rainwater has been collected, it may be considered raw water and the raw water may be circulated periodically through a treatment system prior to filtration and disinfection.

### FIELD OF THE INVENTION

The present invention relates to the field of rainwater collection, and more particularly to an improved rainwater collection system with an automatic rinse system for improved water quality.

### DESCRIPTION OF THE RELATED ART

Prior art rainwater collection systems are typically designed to capture, store, filter, disinfect, and preserve rainwater such that it may be potable water. FIG. 1 shows a typical prior art process for the collection of rainwater. As shown, at 101, the rainwater collection system may capture the rainwater. Typically, the rainwater collection process starts on the roof of a building. Initially, the rainwater may be allowed to drain similar to a typical gutter system. The amount of rainwater that is drained before actual collection may begin may be based on locality and may generally be a function of roof space. For example, one locality may require 10 gallons of rainwater per one thousand square feet of roof space to drain off through the gutter system prior to collection. Once the gallons requirement has been met, the rainwater may be collected into raw water tanks as shown at 102. From the raw water tanks, the rainwater, now considered raw water, may be pumped through a filtration process at 103 and continue on to a finish raw water storing tank. From here, the raw water may be disinfected via an ozone and ultraviolet light treatment. Finally, at 105, the disinfected water may be preserved.

The prior art system described above is generally highly manual and labor intensive because physical input may be required at each stage. This may lead to many inefficiencies and losses throughout the system. For example, at the initial collection phase, workers must be present when the rainfall starts in order for the process of collection to begin. A delay in starting the process may result in loss of water collection capacity for a given rainfall. Additionally, workers must be present to determine when the gallons requirement has been met and switch the flow of the rainwater into the collection tanks.

Further refinement of the storage process may lead to improved product quality and the collection of higher quality rainwater. Thus, improvements to the system are needed.

### SUMMARY OF THE INVENTION

Various embodiments of systems and methods for improved rainwater collection are presented below. In an exemplary embodiment, a rainwater collection system may include multiples valves and water holding tanks. Additionally, the rainwater collection system may include a flow meter, a measurement system, and a controller. A first valve may be coupled to a gutter system of a building. In one embodiment the first valve may be a normally open valve. The flow meter may be coupled to the first valve and to a first tank. The first tank may include the measurement system. The measurement system may be configured to measure parameters associated with the flow of rainwater such as pH level and rainwater clarity, for example. The parameters associated with the flow of rainwater may also include rainwater temperature and rainwater volume.

At least one second valve may also be coupled to the gutter system. In one embodiment the second valve(s) may be normally open valves. Further, a second tank may be coupled to the second valve(s).

The rainwater collection system may also include a controller. The controller may be configured to detect a flow of rainwater via the flow meter and measure parameters associated with the flow of rainwater via the measurement system. Accordingly, the controller may be configured to determine that each of the parameters may have met a respective criterion and, in response, may automatically switch the first valve and the at least one second valve to re-direct the flow of rainwater to the second tank for holding the collected rainwater. Switching the first valve and the at least one second valve may include switching the valves from an open to a closed position. The criteria may include a minimum pH level, a maximum pH level, a range of pH levels, and/or a clarity value.

In certain embodiments, the second tank may be a raw water holding tank, and the collected rainwater may be considered raw water. Further, in such embodiments, the rainwater collection system may also include a pump coupled to the second tank and a treatment system coupled to the pump. The treatment system may be configured to disinfect the raw water and the pump may be configured to pump the raw water through the treatment system and return disinfected raw water to the raw water holding tank. The treatment system may be configured to disinfect the raw water with an ozone treatment.

A method for collecting rainwater may include detecting a flow of rainwater via a flow meter and, in response, automatically switching a first valve to direct the flow of rainwater through a first tank. The first tank may include a measurement system that measures parameters associated with the flow of rainwater via the measurement system. The parameters may include pH level and rainwater clarity. In response to determining that each of the parameters has met a respective criterion, the method may automatically switch at least one second valve to re-direct the flow of rainwater to a second tank for holding collected rainwater.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an example rainwater collection system according to prior art;

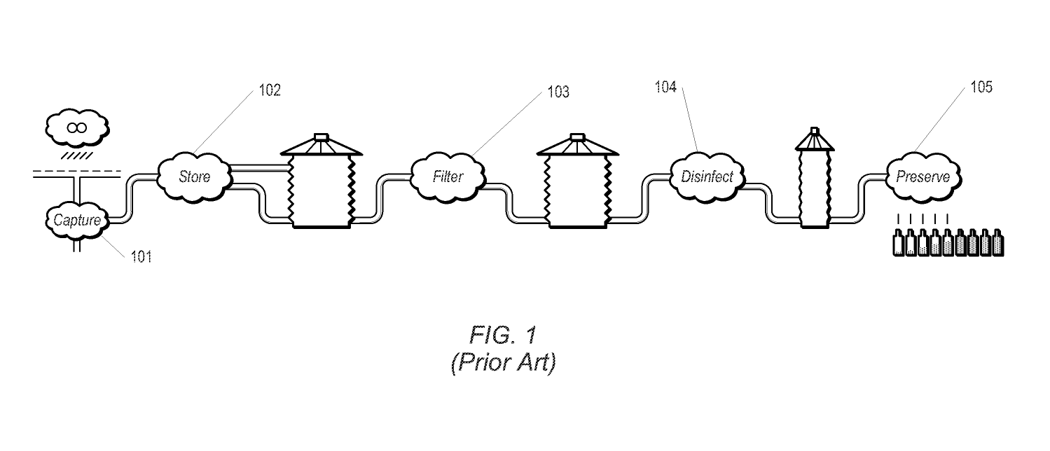

FIG. 2 illustrates an exemplary rainwater collection system configured according to embodiments of the invention;

FIG. 3 illustrates an automated rinse system of an exemplary rainwater collection system according to an embodiment;

FIG. 4 illustrates a raw water treatment system of an exemplary rainwater collection system according to an embodiment;

FIG. 5 illustrates a filtration system of an exemplary rainwater collection system according to an embodiment;

FIG. 6 illustrates a treatment system of an exemplary rainwater collection system according to an embodiment; and

FIG. 7 illustrates a block diagram of a method for rainwater collection according to an embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of non-transitory computer accessible memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. The term “program” includes 1) a software program which may be stored in a memory and is executable by a processor or 2) a hardware configuration program useable for configuring a programmable hardware element.

Computer System—any of various types of computing or processing systems, including a personal computer system (PC), mainframe computer system, workstation, network appliance, Internet appliance, personal digital assistant (PDA), television system, grid computing system, tablet devices, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Functional Unit (or Processing Element)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Controller—refers to one or more computer systems and/or functional units configured to control one or more devices and/or processes. A controller may be coupled to measurement systems as well as devices such as valves and pumps, among other devices. A controller may operate in an open loop system in which the controller may not receive feedback from coupled measurement systems and devices. Alternatively, a controller may operate in a closed loop system in which the controller may receive feedback from coupled measurement systems and devices. A controller may be coupled to the measurement systems and devices via a wired connection or via a wireless connection. A controller may be coupled to measurement systems and devices via a local area network (LAN) or via a wide area network (WAN), such as the internet. Thus, a controller may be considered web-based. A controller may operate in real time. In other words, a controller may operate in a deterministic manner.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third component electrically connected to the module substrate” does not preclude scenarios in which a “fourth component electrically connected to the module substrate” is connected prior to the third component, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112, paragraph six, interpretation for that component.

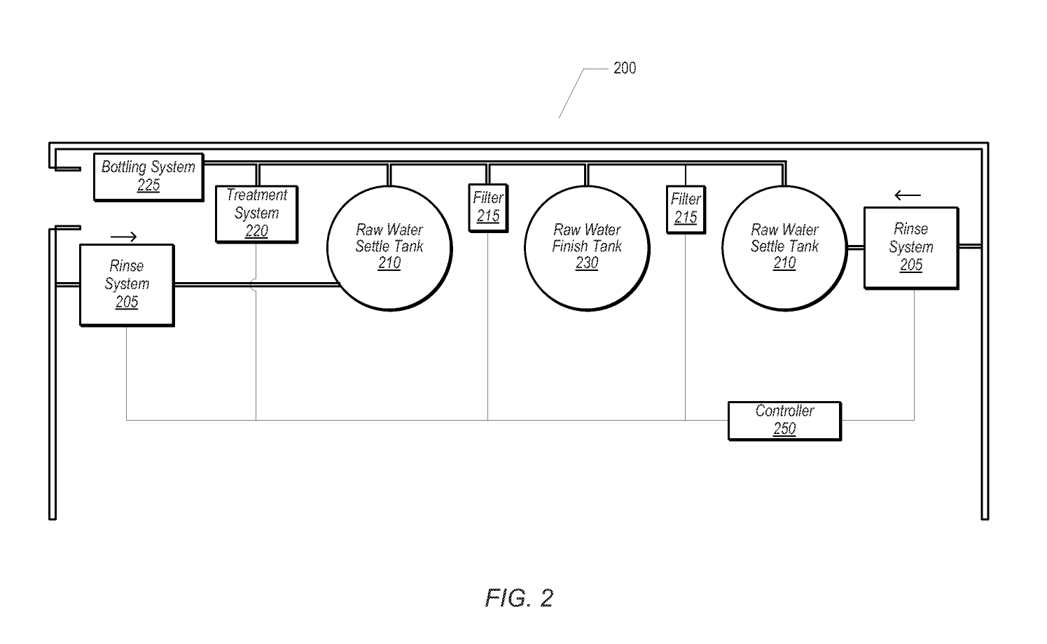

### FIGS. 2-7 Exemplary Rainwater Collection System

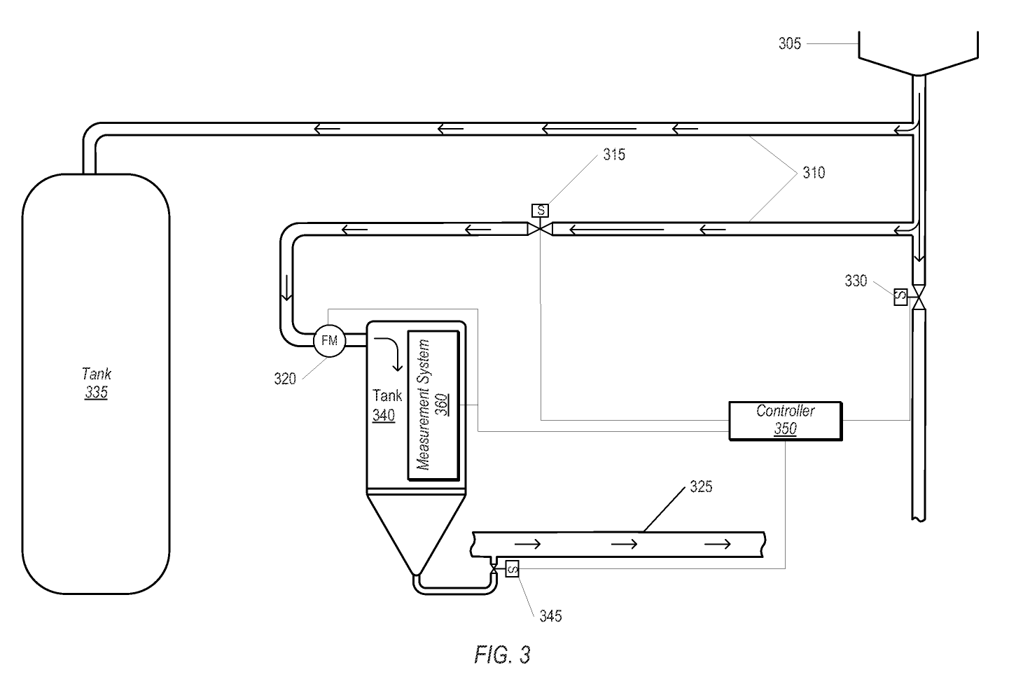

FIG. 2 illustrates an exemplary rainwater collection system according to one embodiment. Rainwater enters rainwater collection system 200 via automated rinse systems 205. Automated rinse systems 205, more fully described below in reference to FIG. 3, may be triggered by detecting flow in the system via a flow meter or other appropriate device. Automated rinse systems 205 may measure one or more parameters, such as volume of rainwater flowing through automated rinse systems 205, pH of the rainwater, clarity or turbidity of the rainwater, and temperature of the rainwater, among other parameters.

Automated rinse systems 205 may include, or be coupled to, a controller, such as controller 250. As defined above, the term controller generally refers to one or more computer systems and/or functional units configured to control one or more devices and/or processes. Controller 250 may be coupled to measurement systems as well as devices, such as valves and pumps, among other devices. Controller 250 may operate in an open loop system in which controller 250 may not receive feedback from coupled measurement systems and devices. Alternatively, controller 250 may operate in a closed loop system in which the controller may receive feedback from coupled measurement systems and devices. Controller 250 may be coupled to the measurement systems and devices via a wired connection or via a wireless connection. For example, controller 250 may be coupled to measurement systems and devices via a LAN or via a WAN, such as the Internet. Thus, controller 250 may be considered web-based. Controller 250 may operate in real time. In other words, controller 250 may operate in a deterministic manner.

Controller 250 may monitor the parameters and determine whether and/or when one or more of the parameters achieve specified criterion associated with each parameter. Additionally, controller 250 may log data regarding the parameters being measured to a server. The server may be coupled to the controller via a LAN and/or WAN.

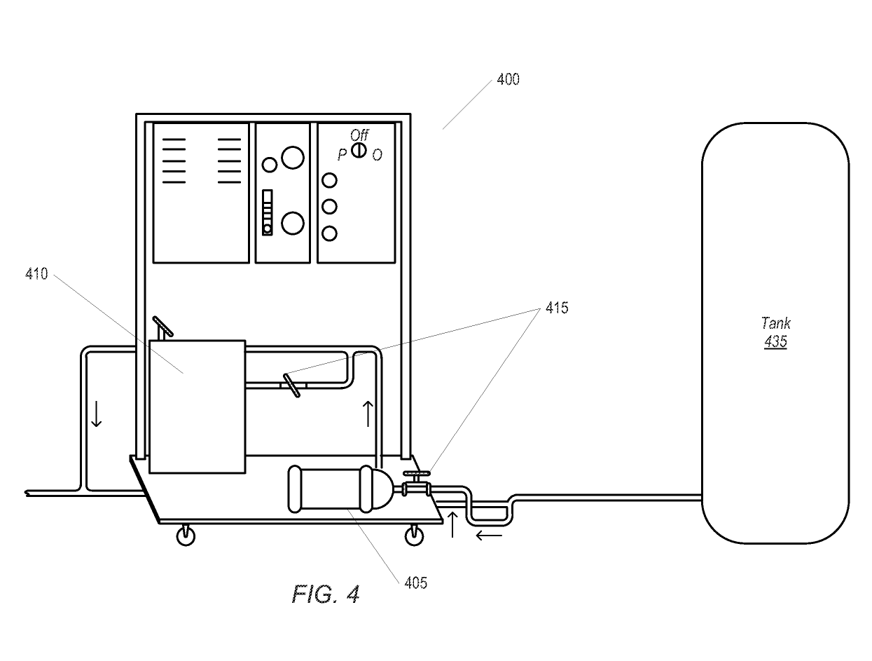

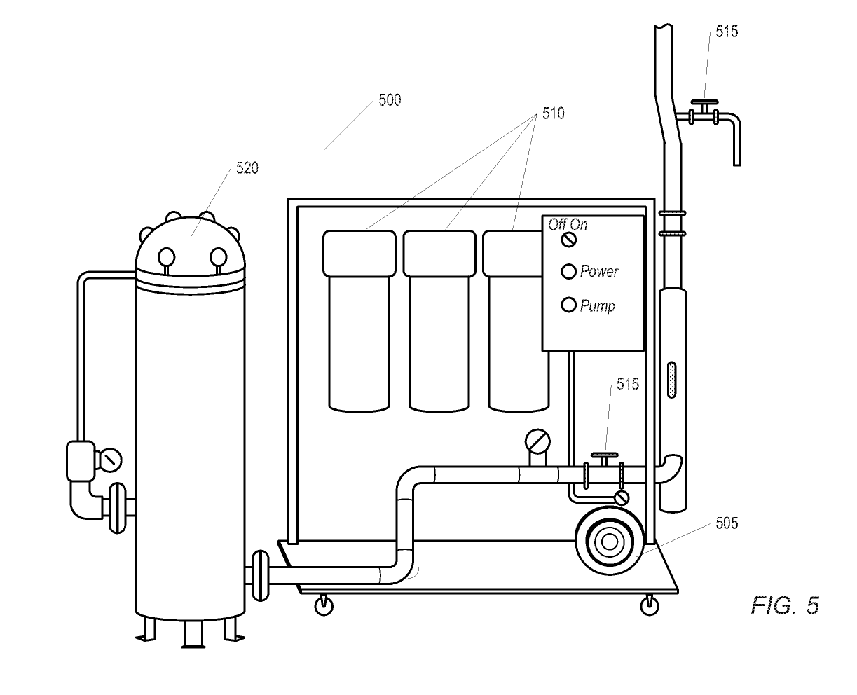

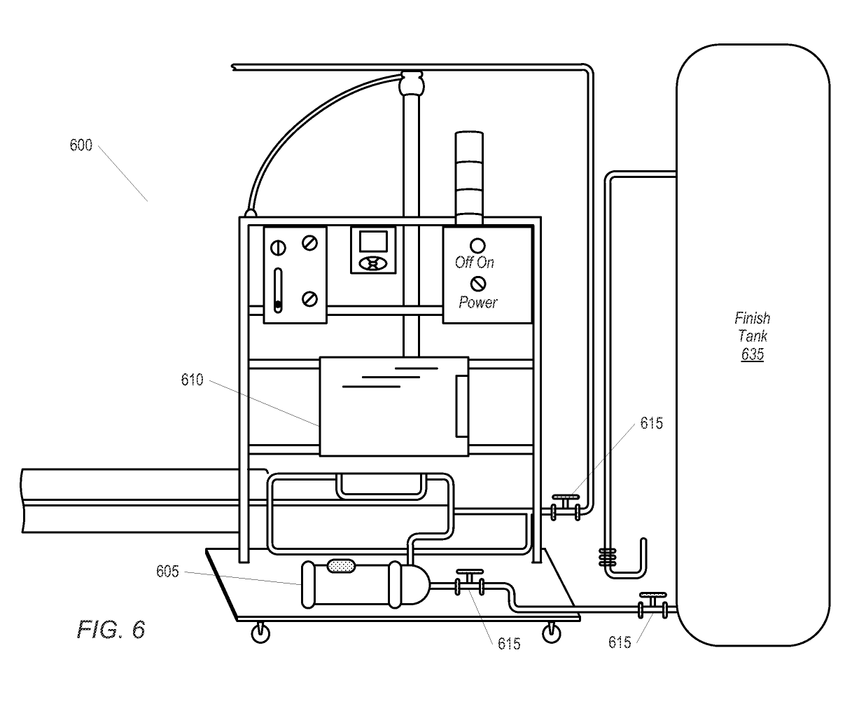

Controller 250 may determine that each of the parameters has achieved, or obtained, the associated criterion, and in response, controller 250 may switch a valve coupled to, or included in, automatic rinse systems 205. Additionally, controller 250 may switch one or more valves used for flushing rainwater collection system 200. Accordingly, the flow of the rainwater may be redirected to raw water settle tanks 210. In some embodiments, the switching of the valves may be performed concurrently. After the rainwater has been diverted into settling tanks 210, it may be considered raw water, and the raw water may be periodically aerated and injected with ozone as more fully described below in reference to FIG. 4. The raw water may then be pumped through filtration systems 215, more fully described below in reference to FIG. 5, to raw water finish tank 230. Finally, the filtered raw water may be pumped through treatment system 220, more fully described below in reference to FIG. 6, and then the treated water may be bottled via bottling system 225.

FIG. 3 illustrates an automated rinse system according to an embodiment. The automated rinse system may be included in a rainwater collection system, such as rainwater collection system 200 described above in reference to FIG. 2. In an exemplary embodiment, as rain begins to fall, rainwater may be directed from a building roof into gutter system 305 and may be allowed to enter the building via plumbing 310 as illustrated in FIG. 3. The gutter system may include a series of National Science Foundation (NSF) certified exterior pipes and drain outside, similar to a normal gutter system. The rainwater may flow through valve 315 and towards flow meter 320. For example, valve 315 may be an automated butterfly valve and may be configured to be normally open. Further, valve 330, may be coupled to plumbing 310. Similar to valve 315, valve 330 may be an automated butterfly valve and may be configured to be normally open. Note that valve 330 may be located on the interior or exterior of the building and may be one of multiple valves 330. Further, valve(s) 330 may be configured to close the system and redirect the flow of rainwater towards tank 335 when closed. Note further that tank 335 is representative only, and an automated rinse system, and more generally, a rainwater collection system, may include multiple tanks 335 for storing collected rainwater, i.e., raw water.

Flow meter 320 may detect the rainwater entering the rainwater collection system via plumbing 310. Flow meter 320 may be monitored by a controller, such as controller 350. Controller 350 may be similar to or the same as controller 250 described above with reference to FIG. 2. Thus, controller 350 may be coupled to, or included in, the automated rinse system. In an exemplary embodiment, controller 350 may monitor a measurement system, such as measurement system 360 that may be included in tank 340. Tank 340 may be coupled to flow meter 320. Measurement system 360 may be configured to measure multiple parameters of the flow of rainwater. For example, measurement system 360 may be configured to measure rainwater pH level and rainwater clarity, or rainwater turbidity via sensors such as pH sensors and conductivity sensors. Note that the conductivity of the rainwater may be used as a measure of clarity. Additional parameters such as rainwater temperature and volume of rainwater flowing through the automated rinse system may also be measured via temperature and flow sensors. Controller 350 may be coupled to a server via a LAN and/or a WAN and may log and report data from measurement system 360. The data may be logged and reported in real time and may be stored on the server and accessible via the LAN and/or WAN.

Controller 350 may be configured to detect the flow of rainwater through the flow meter and, in response, switch valve 345. Switching valve 345, which may be a normally closed valve, may allow the rainwater to flow through tank 345 and out of the rainwater collection system via plumbing 325. Additionally, controller 350 may be configured to monitor the multiple parameters via measurement system 360 and compare each of the parameters to a respective criterion. The criterion may include a minimum pH level, a maximum pH level, a range of pH levels, and a clarity value, among other criterion. In response to determining that the criteria have been met, controller 350 may switch valve 315 and may additionally switch valve 330 which may direct the flow of the rainwater to tank 335. Switching of valve 315 and valve 330 may be automatic and may be performed concurrently.

FIG. 4 illustrates a raw water treatment system of an exemplary rainwater collection system according to an embodiment. Raw water treatment system 400 may be included in a rainwater collection system as described above in reference to FIG. 2. In other embodiments, the raw water treatment system may be included in, or coupled to, an automated rinse system, such as the system described above in reference to FIG. 3. As shown, raw water treatment system 400 may include pump 405, treatment device 410, and valves 415. The raw water treatment system 400 may be coupled to a raw water holding tank, such as tank 435. Note that tank 435 may be similar to or the same tank as tank 335 described above in reference to FIG. 3. Additionally, treatment device 410 may be an ozone treatment system. As shown, the pump 405 may be configured to pump raw water from tank 435 through treatment device 410. The flow of the raw water through raw water treatment system 400 may be directed by valves 415. A controller, similar to or the same as controllers 250 and 350 described above in reference to FIGS. 2 and 3, may be coupled to raw water treatment system 400 and may be configured to control pump 405, treatment device 410, and valves 415. In an exemplary embodiment, treatment device 410 may disinfect the raw water via an ozone treatment.

FIG. 5 illustrates a filtration system of an exemplary rainwater collection system according to an embodiment. In an exemplary embodiment, filtration system 500 may be similar to or the same as filtration system 215 described above in reference to FIG. 2. As shown, filtration system 500 may include pump 505, filters 510, valves 515, and ultraviolet treatment tank 520. Raw water may be pumped via pump 505 from a raw water collection tank, such as tanks 335 and 435 described above in reference to FIGS. 3 and 4, through filters 510 and ultraviolet treatment tank 520 and into a raw water finish tank. Filters 510 may include a 25 micro-meters (μm) exterior/1-micron interior filter cartridge, a 0.35 μm filter cartridge, and a long term two (LT2) ultra-filtration (UF) cartridge. Note that UF is defined as a pressure-driven membrane filtration process that typically employs hollow-fiber membranes with a pore size range of approximately 0.01-0.05 μm. A controller, similar to or the same as controllers 250 and 350 described above in reference to FIGS. 2 and 3, may be coupled to filtration system 500 and may be configured to control pump 505, valves 515, filters 510, and ultraviolet treatment tank 520.

FIG. 6 illustrates a treatment system of an exemplary rainwater collection system according to an embodiment. Treatment system 600 may be similar to or the same as treatment system 220 described above in reference to FIG. 2. As shown, treatment system 600 may include a pump 605, a treatment device 610, and valves 615. Treatment device 610 may be configured to generate ozone and pump 605 may be configured to circulate the filtered water through treatment device 610 to disinfect the water and produce potable drinking water. Valves 615 may be configured to direct the flow of water through treatment device 610. A controller, similar to or the same as controllers 250 and 350 described above in reference to FIGS. 2 and 3, may be coupled to treatment system 600 and may be configured to control pump 605, valves 615, and treatment device 610.

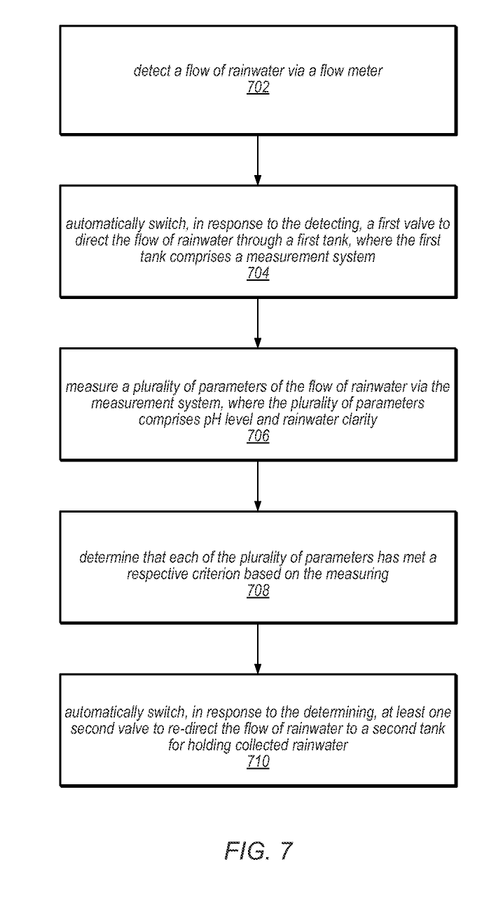

### FIG. 7: Block Diagram of a Method for Rainwater Collection

FIG. 7 illustrates an exemplary embodiment of a method for collecting rainwater. The method shown in FIG. 7 may be used in conjunction with any of the systems or devices shown in the above Figures, among other devices. In various embodiments, some of the method elements shown may be performed concurrently, in a different order than shown, or may be omitted. Additional method elements may also be performed as desired. As shown, this method may operate as follows.

At 702, flow of rainwater may be detected via a flow meter. The flow meter may be coupled to a controller. The controller may be similar to or the same as controllers 250 and 350 described above in reference to FIGS. 2 and 3. The flow meter may log flow data, such as rate of flow and volume, and transmit the data to the controller. The flow meter may transmit the data wirelessly or via a wired connection. The data logging may be triggered by an event, such as an initial detection of flow through the meter. Alternatively, the controller may receive a signal from the flow meter and may measure the flow via the received signal.

At 704, in response to detecting the flow of rainwater, a first valve may be automatically switched to direct the flow of the rainwater through a first tank that may include a measurement system. The first valve may be a solenoid valve and may be coupled to the controller. In an exemplary embodiment, the first valve may be automatically switched opened in order to direct the flow through the first tank.

At 706, a plurality of parameters associated with the flow of rainwater may be measured via the measurement system. The parameters may include pH level and rainwater clarity, or turbidity. In some embodiments, the parameters may include rainwater temperature and/or rainwater volume.

At 708, it may be determined that each of the plurality of parameters may have met a respective criterion based on the measuring. For example, the criterion may include a minimum pH level, a maximum pH level, and/or a range of pH levels. In some embodiments, the criterion may include a clarity value or level. The controller may monitor and determine when each of the plurality of parameters has met a respective criterion. The controller may operate in real time and may be coupled to the measurement system via a LAN or WAN.

At 710, in response to determining that each of the plurality of parameters may have met the respective criterion, at least one second valve may be automatically switched to re-direct the flow of the rainwater to a second tank for holding the collected rainwater. The collected rainwater may be raw water and the second tank may be a raw water holding tank. Additionally, in certain embodiments, the second valve may be controlled by a controller and may be automatically switched concurrently with the first valve being automatically switched to re-direct the rainwater to the second tank.

In a further embodiment in which the rainwater may be collected in a raw water holding tank, the method may further include pumping the raw water through a treatment system, treating the raw water via the treatment system, and returning the raw water to the raw water holding tank. Treating the raw water may include disinfecting the raw water via an ozone treatment. Additionally, the controller may be configured to control the pump and the treatment system.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for collecting rainwater, comprising
detecting a flow of rainwater via a flow meter;
automatically switching, in response to the detecting, a first valve to direct the flow of rainwater through a first tank, wherein the first tank comprises a measurement system;
measuring a plurality of parameters of the flow of rainwater via the measurement system, wherein the plurality of parameters comprises pH level and rainwater clarity;
determining that each of the plurality of parameters has met a respective criterion based on the measuring; and
automatically switching, in response to the determining, at least one second valve to re-direct the flow of rainwater to a second tank for holding collected rainwater.

2. The method of claim 1, wherein the second tank comprises a raw water holding tank, and wherein the collected rainwater is raw water.

3. The method of claim 1, wherein the second tank comprises a raw water holding tank, and wherein the collected rainwater is raw water, and wherein the method further comprises:
pumping the raw water through a treatment system;
disinfecting the raw water via the treatment system; and
returning the raw water to the raw water holding tank after said disinfecting.

4. The method of claim 1, wherein said disinfecting comprises disinfecting the raw water with an ozone treatment.

5. The method of claim 1, wherein the plurality of parameters further comprise at least one of:
rainwater temperature; and
rainwater volume.

6. The method of claim 1, wherein the respective criterion comprises at least one of:
a minimum pH level;
a maximum pH level; and
a range of pH levels.

7. The method of claim 1, wherein the respective criterion comprises:
a clarity value.

8. A rainwater collection system, comprising:
a first valve coupled to a gutter system of a building, wherein the first valve is a normally open valve;
a flow meter, coupled to the first valve;
a first tank, coupled to the flow meter;
a measurement system, comprised in the first tank, wherein the measurement system is configured to measure a plurality of parameters of the flow of rainwater, wherein the plurality of parameters comprises pH level and rainwater clarity;
at least one second valve coupled to the gutter system, wherein the at least one second valve is a normally opened valve;
a second tank, coupled to the at least one second valve; and
a controller, wherein the controller is configured to:
detect a flow of rainwater via the flow meter;
receive measurements of the plurality of parameters of the flow of rainwater via the measurement system;
determine that each of the plurality of parameters has met a respective criterion based on the measurements; and
automatically switch, in response to determining that respective criterion has been met, the first valve to a closed position and the at least one second valve to an closed position to re-direct the flow of rainwater to the second tank for holding collected rainwater.

9. The rainwater collection system of claim 8, wherein the second tank comprises a raw water holding tank, and wherein the collected rainwater is raw water.

10. The rainwater collection system of claim 8, wherein the second tank comprises a raw water holding tank, and wherein the collected rainwater is raw water, and wherein the rainwater collection system further comprises:
a pump coupled to the second tank; and
a treatment system coupled to the pump, wherein the treatment system is configured to disinfect the raw water; and
wherein the pump is configured to pump the raw water through the treatment system and return disinfected raw water to the raw water holding tank.

11. The rainwater collection system of claim 10, wherein the treatment system is configured to disinfect the raw water with an ozone treatment.

12. The rainwater collection system of claim 8, wherein the plurality of parameters comprises at least one of:
rainwater temperature; and
rainwater volume.

13. The rainwater collection system of claim 8, wherein the respective criterion comprises at least one of:
a minimum pH level;
a maximum pH level; and
a range of pH levels.

14. The rainwater collection system of claim 8, wherein the respective criterion comprise:
a clarity value.

15. A method for collecting rainwater, comprising:
detecting a flow of rainwater;
directing the flow of rainwater through a measurement system in response to the detecting;
measuring a plurality of parameters of the flow of rainwater via the measurement system;
determining that each of the plurality of parameters has met a respective criterion;
re-directing, in response to each of the plurality of parameters meeting the respective criterion, the flow of rainwater to a collection tank for holding collected rainwater.

16. The method of claim 15,
wherein the directing the flow comprises directing the flow of rainwater to a first tank, wherein the first tank comprises the measurement system; and
wherein the re-directing the flow comprises automatically switching a valve, wherein the automatically switching the valve directs the flow of rainwater from the first tank to the collection tank.

17. The method of claim 9, wherein the collection tank comprises a raw water holding tank, and wherein the collected rainwater is raw water, and wherein the method further comprises:
pumping the raw water through a treatment system;
treating the raw water via the treatment system; and
returning the raw water to the raw water holding tank.

18. The method of claim 15, wherein the plurality of parameters comprise at least one of:
rainwater temperature;
rainwater pH level;
rainwater clarity; and
rainwater volume.

19. The method of claim 15, wherein the respective criterion comprises at least one of:
a minimum pH level;
a maximum pH level; and
a range of pH levels.

20. The method of claim 15, wherein the respective criterion comprises:
a maximum clarity value.
